(19) United States
(12) Patent Application Publication
(10) Pub. No.: US 2006/0270394 A1
(43) Pub. Date: Nov. 30, 2006

(54) Multi- stage hardware button for mobile devices

(75) Inventor: Peter Chin, Seattle, WA (US)

Correspondence Address: MERCHANT & GOULD PC, P.O. BOX 2903, MINNEAPOLIS, MN, 55402-0903, US

(73) Assignee: Microsoft Corporation, Redmond, WA (US)

(21) Appl. No.: 11/137,086

(22) Filed: May 24, 2005

(51) Int. Cl. H04Q 7/20

(52) U.S. Cl. 455/418; 455/566

(57) ABSTRACT

Exemplary embodiments disclosed herein may also include a mobile communication system, including an application module executing an application program, a user interface portion comprising a multi-stage actuator, where the multi-stage actuator is programmed to activate different functions when actuated in different positions, based at least in part upon the application program.

### TECHNICAL FIELD

The present invention relates generally to the field of computer and mobile communication devices. More particularly, the present invention relates to an actuator utilized in a mobile communication device system.

### BACKGROUND

The emergence of the cellular telephone technology in recent years has revolutionized the telecommunications industry. Where in the past telephones were largely confined to homes, offices, and other stationary structures, cellular telephone technology has made it possible for telephone to be truly portable and exist nearly anywhere.

Recently, the technology behind cellular phones has advanced to the point where the size of the device has decreased greatly and users increasingly desire smaller devices. Meanwhile the technical capabilities of these devices have increased. Indeed, these small handheld devices are computer systems with advances capabilities. Over time, more and applications are included with these mobile devices.

Unfortunately, as more applications are added to these mobile devices, more user input elements (such as buttons) are needed to provide the functionality to the applications. More specifically, given the decreasing size of the devices, it is becoming difficult to add more input elements.

It is with respect to these considerations that the present invention has been made.

### SUMMARY

Exemplary embodiments disclosed herein relate to systems and methods for mobile communications including a user interface with a multistage actuator. Exemplary embodiments disclosed herein may also include a mobile communication system, including an application module executing an application program, a user interface portion comprising a multi-stage actuator, where the multi-stage actuator is programmed to activate different functions when actuated in different positions, based at least in part upon the application program.

Exemplary embodiments may be implemented as a computer process, a computing system or as an article of manufacture such as a computer program product. The computer program product may be a computer storage medium readable by a computer system and encoding a computer program of instructions for executing a computer process. The computer program product may also be a propagated signal on a carrier readable by a computing system and encoding a computer program of instructions for executing a computer process.

A more complete appreciation of the present disclosure can be obtained by reference to the accompanying drawings, which are briefly summarized below, and to the following detailed description of exemplary embodiments, and to the appended claims.

### BRIEF DESCRIPTION OF THE DRAWINGS

FIG. 1 is a plan view of a prior art 6-button mobile communication device.

FIG. 2 is a plan view of a mobile communication device with programmable, multistage actuators, according to an exemplary embodiment.

FIG. 3 illustrates an example of a suitable computing system environment on which exemplary embodiments may be implemented.

FIG. 4 is cross sectional view of the device of FIG. 2 along lines 4-4, showing multistage actuators and actuation positions, according to an exemplary embodiment.

FIG. 5 is a block diagram of a mobile communication system, according to an exemplary embodiment.

FIG. 6 is a flow diagram of a method of determining the actuation position of a multi-stage actuator, according to an exemplary embodiment.

FIG. 7 shows the user interface portion with the focus located by a cursor, according to an exemplary embodiment.

FIG. 8 is a block diagram of a mobile communication system, according to an exemplary embodiment.

FIG. 9 is a block diagram of a mobile communication system, according to an exemplary embodiment.

FIG. 10 is a flow diagram of a method of determining the focus of a document, according to an exemplary embodiment.

FIG. 11 is a document according to an exemplary embodiment.

### DETAILED DESCRIPTION

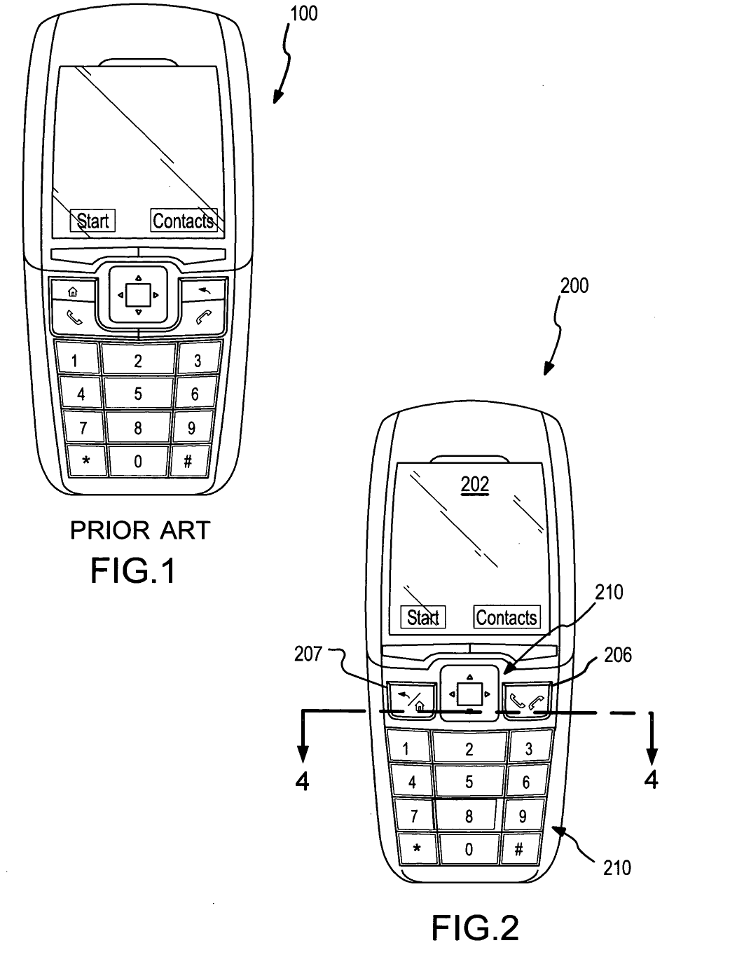

FIG. 1 is plan view a prior art mobile communication device 100. As can be seen, there are 6 buttons, excluding the numeric buttons, as shown. For a small device, the buttons must be correspondingly small, which limits the functionality of the system, and makes the system difficult to operate. Furthermore, there is a limited amount of surface area available for input elements for this configuration. This limited amount of surface area creates a corresponding limitation on the size, and number, of functional input elements allowable for this system.

A mobile communications device 200 having aspects of the present invention is shown in FIG. 2. In this embodiment, device 200 has a display 202. Display 202 may display various applications, documents, prompts and other indicators as desired.

Device 200 also has a multi-stage actuators 206 and 207, as well as other user input elements 210. Multi-stage actuators 206 and 207 have multiple actuation positions, such that different functions are activated or associated with the different actuation positions of multi-stage actuators 206 and 207. With this configuration, the amount of surface area needed for buttons may be decreased and while maintaining or increasing the functionality of the system. Furthermore, although two multi-stage actuators 206 and 207 are shown, it will be appreciated that one, two or many more multi-stage actuators may be utilized to further reduce the area required for the user input portion.

The device 200 includes software that evaluates the information displayed by the display 202, and programs the user elements 206 and 207 to default, common and/or preferred functionality. It will be appreciated that the functions activated by the various stages of actuation of multi-stage actuators 206 and 207, and other user input portion elements 210, may be wholly unrelated. However, they also may be closely related as desired.

Multi-stage actuator 206 may have a first actuation position corresponding to a first level that multi-stage actuator 206 is depressed, and a second actuation position at a second level, below the first level. Furthermore, to actuate to the second stage there may be a time delay at the first actuation position, such that a user may not inadvertently activate at the first position, and consequently, activate more than one function. It will be appreciated that the different functions of the multi-stage actuator 206 may be related such that a user may want to activate a function associated with the first position first, and a second function associated with the second position thereafter.

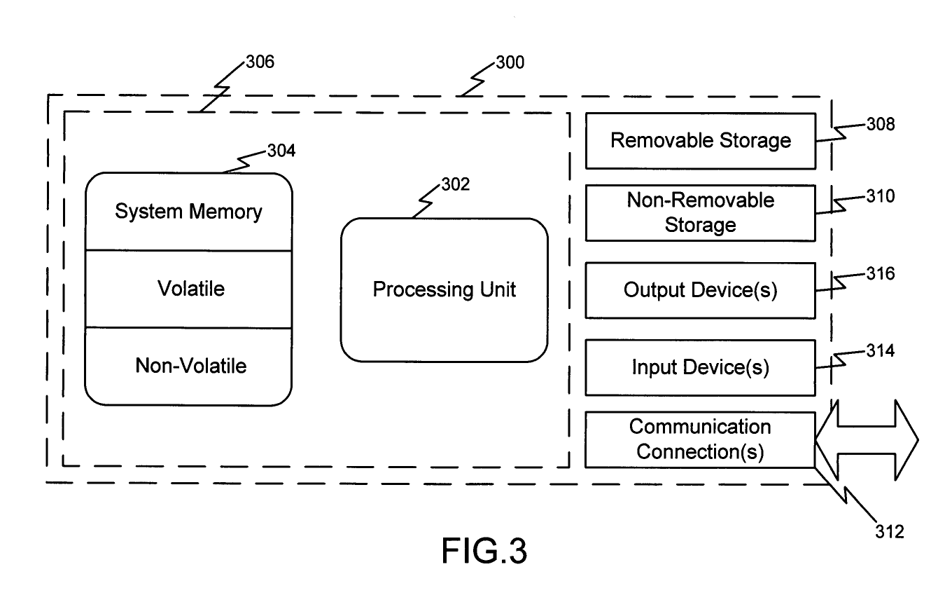

FIG. 3 illustrates an example of a suitable computing system environment on which exemplary embodiments may be implemented. This system 300 is representative of one that may be used to serve as a client and/or a server as described above. In its most basic configuration, system 300 may include at least one processing unit 302 and memory 304. Depending on the exact configuration and type of computing device, memory 304 may be volatile (such as RAM), non-volatile (such as ROM, flash memory, etc.) or some combination of the two. This most basic configuration is illustrated in FIG. 3, generally at 306.

Additionally, system 300 may also have additional features/functionality. For example, device 300 may also include additional storage (removable and/or non-removable) or access additional storage including, but not limited to, magnetic or optical disks or tape. Such additional storage is illustrated in FIG. 3 by removable storage 308 and non-removable storage 310. Computer storage media may include volatile and nonvolatile, removable and non-removable media implemented in any method or technology for storage of information such as computer readable instructions, data structures, program modules or other data. Memory 304, removable storage 308 and non-removable storage 310 are all examples of computer storage media. Computer storage media may include, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by system 300, or combinations thereof Any such computer storage media may be part of the overall system 300.

System 300 may also contain communications connection(s) 312 that allow the system to communicate with other devices. By way of example, and not limitation, communication connections 312 may also include wired connections such as a wired network or direct-wired connection, and wireless connections such as acoustic, RF, infrared and other wireless media. Communications connection(s) 312 is an example means of sending or receiving communication media. Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal.

A computing device, such as system 300, may include at least some form of computer-readable media. Computer readable media may be any available media that can be accessed by the system 300. By way of example, and not limitation, computer-readable media may comprise computer storage media and communication media.

System 300 may also have input device(s) 314 such as keyboard, mouse, pen, voice input device, touch input device, etc. Output device(s) 316 such as a display, speakers, printer, etc. may also be included. All these devices may be well known in the art and need not be discussed at length here. Specifically however, the system 300 has multistage input devices, as described below.

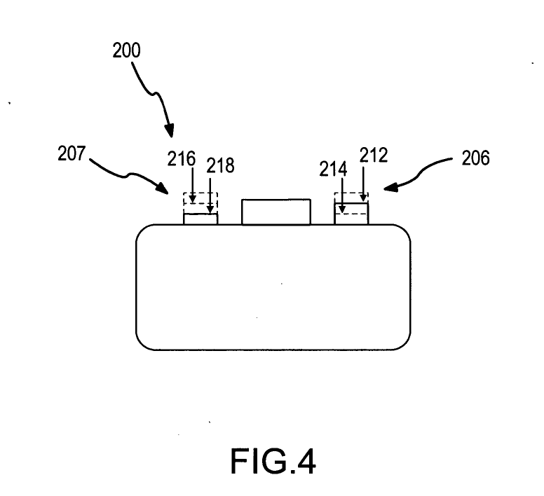

FIG. 4 is a cross sectional view of the mobile communication device of FIG. 2, generally at 200, illustrating multi-stage actuators 206 and 207. FIG. 4 illustrates the different actuation stages, positions, and/or levels for a two-stage actuator, according to an exemplary embodiment. Multi-stage actuator 206 could be actuated to a first position 212, as well as a second position 214. As shown, actuator 206 is depressed to a first position 212 at a first level, and although not shown, actuator 206 may also be depressed to a second position 214 at a second level below the first level. On the other hand, another multistage actuator 207 may also be depressed to either a first level 216, and/or a second level 218, but is shown depressed to the second level 218.

Multi-stage actuators 206 and 207 could be programmed such that a first function is activated at the first position 212, 216 and a second function be activated a second position 214, 218. It will be appreciated that although two actuation positions have been shown, many actuation positions may be utilized without straying from the concepts disclosed herein. The functions may be closely related such as a cut and paste function, but also may be unrelated depending upon the application and the preference of the user, among many other considerations.

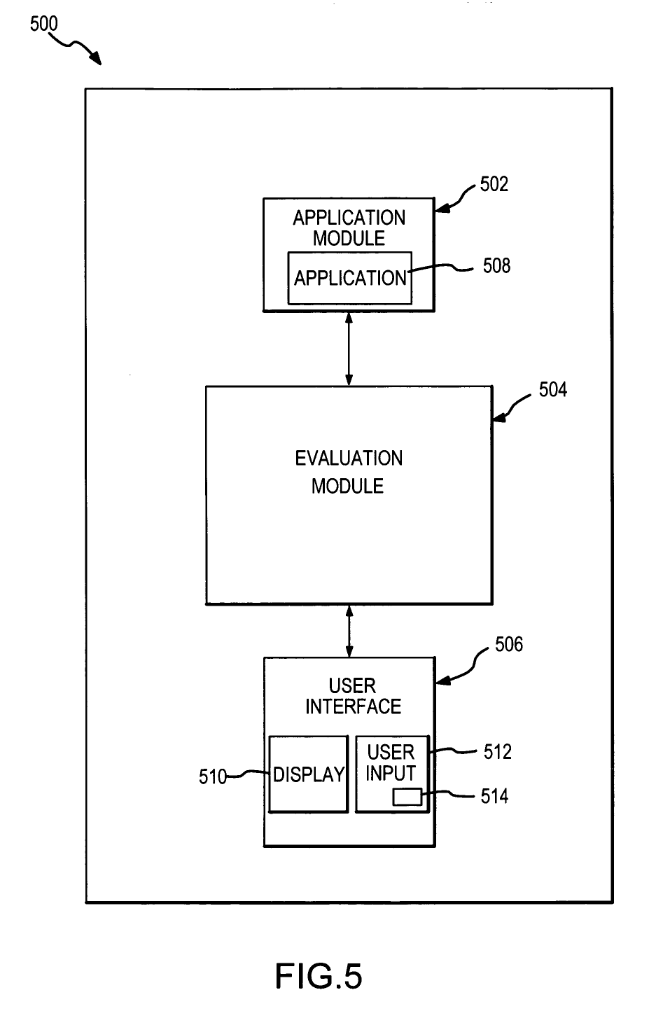

FIG. 5 is a block diagram showing functional module of a mobile communications system 500. In this embodiment system 500 may include an application module 502, which is in communication with and/or communicationally coupled to, evaluation module 504. Evaluation module 504 may in turn be communicationally coupled and/or in communication with, user interface 506.

In an exemplary embodiment, application module 502 may be configured to allow an application 508 to execute and operate within the system 500. The application program 508 may be stored in memory, executed by a processor, and/or executed by an application module 502.

In this exemplary embodiment, user interface 506 includes a display portion 510, as well as a user input portion 512. User input portion 512 includes a multi-stage actuator 514. Display 510 is configured to display information and documents, as well as applications and other functions of the overall system.

The user interface 506 may be configured to display applications, documents and/or other prompts, etc. to the user. Portions of the user interface may be command, control and text portions. Different functionality for user inputs may be programmed based upon the particular portion being addressed, considered, or focused upon. User interface 506 may be hardware, software, firmware, etc. and combinations thereof, as desired.

User input portion 512 includes a keypad with various buttons, actuators, etc., as well as other user input devices, as desired. In this embodiment, evaluation module 504 is configured to evaluate the actuation level of multi-stage actuator 514.

The evaluation module 504 may evaluate variables such as the time, sequence, position, etc. of multi-stage actuator 514. The evaluation of variables is used to determine the function to be executed. Evaluation module 504 may also monitor the inputs coming from user interface 506 and user input portion 512 to further determine default and/or preliminary functionality for user input 512, as well as multi-stage actuator 514.

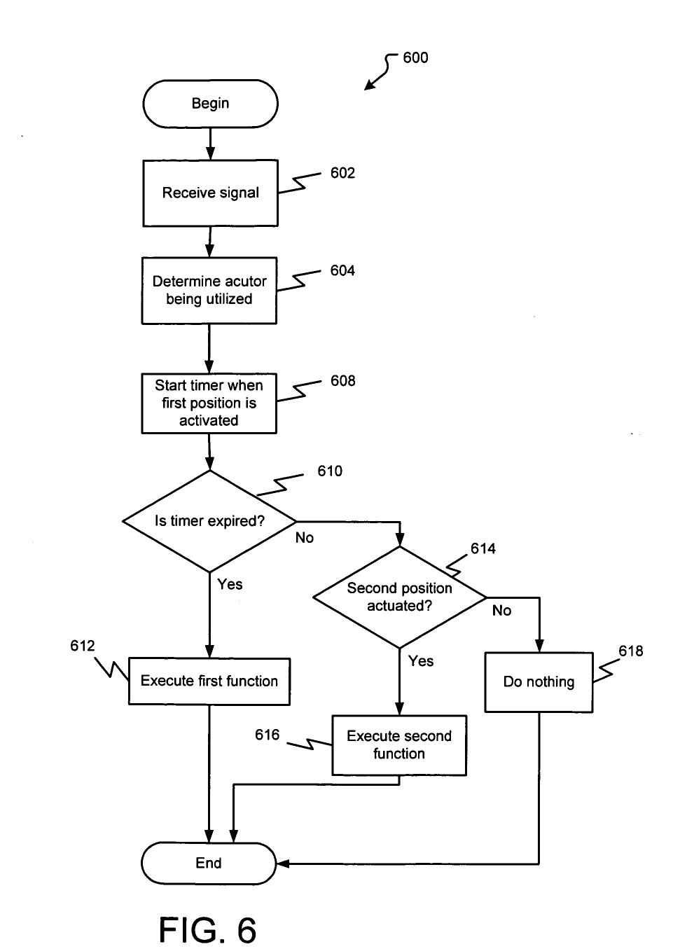

FIG. 6 is a flow diagram of a method 600 of determining the actuation position of a multi-stage actuator, according to an exemplary embodiment. Method 600 includes receiving a signal from a multi-stage actuator at 602 and determining the actuator being utilized at 604. It will be appreciated that these steps may be combined if the actuator is identified within the signal.

Because the first actuation position of a multi-stage actuator will always occur first, the event starts a timer at 608. The timer will remain counting while the actuator is at the first position. The timer may be preset to a predetermined amount of time, which may vary as required or desired. Control then passes to determine function at 610.

If the timer continued to be activated by the actuator being in the first position for the predetermined amount of time, the timer will expire and the function associated with the first position of the actuator will be executed at 612, which correspond to the “Yes” branch form determine function 610.

If the timer is not expired, the “No” branch from determine function 610 is followed to determine function 614, which determines is the actuator is actuated in the second actuation position. If the actuator is actuated in the second position, then the “Yes” branch from determine function 614 is followed to execute block 616. Execute block 616 executes the function associated with the second actuation position of the actuator. Therefore, if the first position timer has not expired, and the second position is actuated, this will indicate that second function should be activated.

If the timer is not expired and the second position of the actuator is not actuated, the “no” branch from determine function 614 is followed and nothing is done at 618. This sequence of events may indicate that the user does not want to activate any function, or that an actuator was inadvertently actuated.

It will be appreciated that this is but one of many algorithms that may be utilized to determine a function to execute in response to the determination of the actuation position and/or sequence of a multi-stage actuator, such as a polling method, among many others. Furthermore, other functionality may be utilized without straying from the concepts disclosed herein.

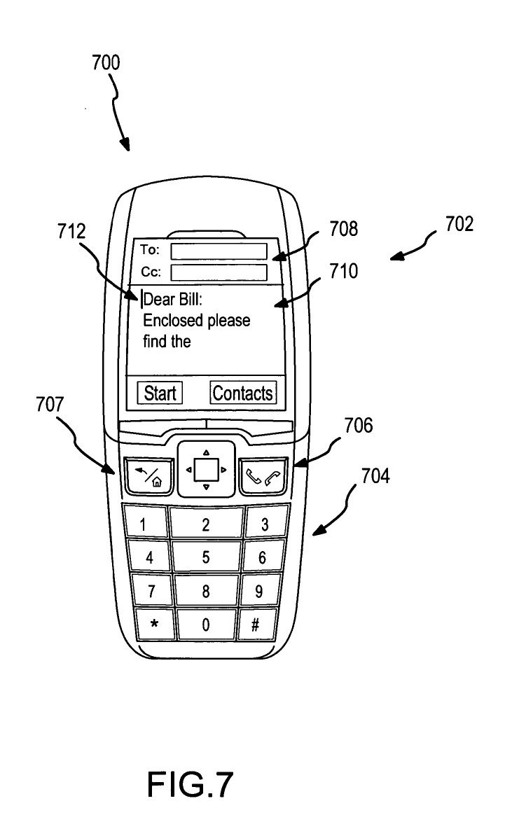

FIG. 7 shows a mobile communication device, generally at 700. In this embodiment, communication device 700 includes a display 702, a user input portion 704, as well as multi-stage actuators 706 and 707.

Display 702 may display a document and/or user interface with differing fields. In this embodiment an email-type document is displayed. The document may have a “To:” and “Cc:” portion 708 as well as a text portion 710. The functionality of multi-stage actuators 706 and 707 may be programmed to activate different functions based upon the portion of the display or document where the “focus” is. Focus may be where the cursor, pointer, and/or other indicator or indication is, or other feature that the application is focusing upon. The focus may be a function of the user interface as well as the application executing, among other indicators and considerations. The system may utilize the focus to determine the functionality of the user inputs.

In this embodiment a focus 712 is shown in test portion 710. As described above, if the focus is in a text portion, the functionality of the buttons may be programmed to text editing type functions. Furthermore, if the focus is on numeric data, numeric editing type functions may be programmed to the user inputs. Similarly, if the focus is in the area denoted by 708, multi-stage actuators 706 and 707 may have address book or other types of programs associated with the various actuation positions and/or algorithms. Similarly, if the focus is on a command or control portion, command or control functionality may be programmed to the user inputs and/or the multi-stage actuator, etc.

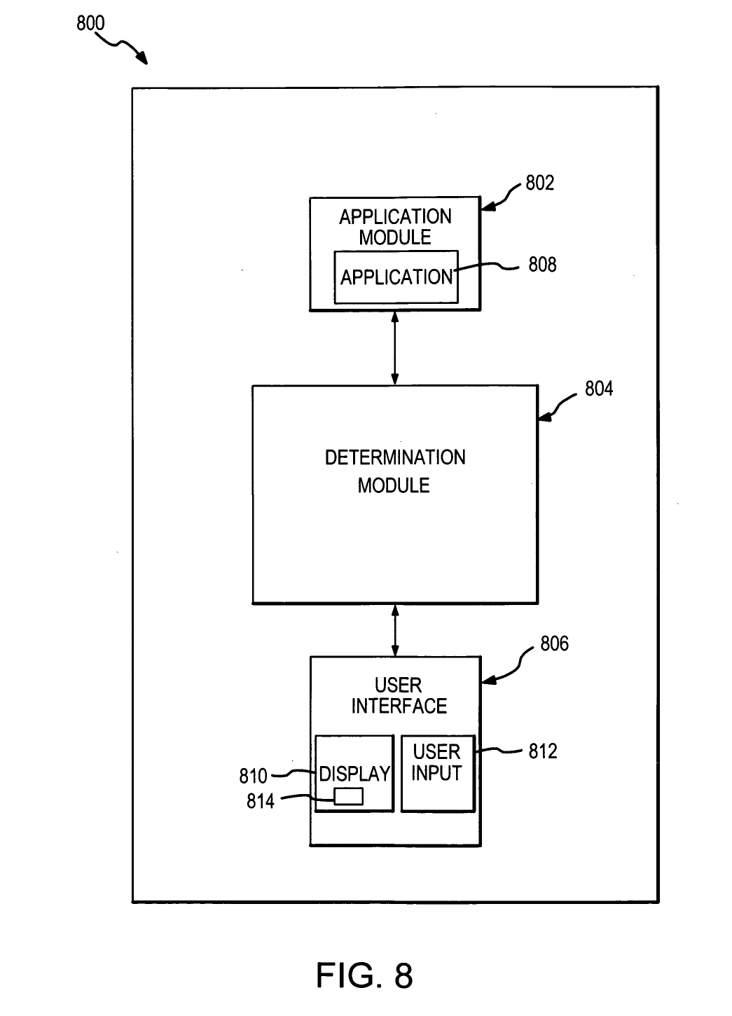

FIG. 8 is a block diagram showing functional module of a mobile communications system 800. In this embodiment system 800 may include an application module 802, which is in communication with and/or communicationally coupled to, determination module 804. Determination module 804 may in turn be communicationally coupled and/or in communication with, user interface 806.

In an exemplary embodiment, application module 802 may be configured to allow an application 808 to execute and operate within the system 500. The application program 808 may be stored in memory, executed by a processor, and/or executed by an application module 802.

In this exemplary embodiment, user interface 806 includes a display portion 810, as well as a user input portion 812. Display 510 is configured to display information and documents, as well as applications and other functions of the overall system. Display portion 810 may also indicate where focus 814 is located. As described above, the focus 814 may be a function of the user interface as well as the application executing, among other indicators and considerations.

The user interface 806 may be configured to display applications, documents and/or other prompts, etc. to the user. Portions of the user interface may be command, control and text portions. Different functionality for user inputs may be programmed based upon the particular portion being addressed, considered, or focused upon. User interface 806 may be hardware, software, firmware, etc. and combinations thereof, as desired.

User input portion 812 includes a keypad with various buttons, actuators, etc., as well as other user input devices, as desired. In this embodiment, determination module 804 is configured to evaluate the focus 814, the application 808, and other indicators and considerations to determine the functionality to be associated with the various user inputs 812.

For example, if application program 808 is an e-mail type application, the functionality of the user inputs may be programmed to have text editor type functionality when the user is focusing in the text portion of the e-mail message. Furthermore, if the application is a word processing type application, again the user input portion 812 may be programmed to have text editing capabilities and functionality. The functions programmed to the various user inputs and/or positions of the multi-stage actuator may include cut, copy, past, delete, select, format, format painter, undo, redo, repeat, paste special, paste hyperlink, find, replace, insert, spell check, thesaurus, save, print, email, etc. among many others.

If application program 808 is a spreadsheet application or other application, and the focus is on a numeric portion of the display and/or document, user input portion 812 may be programmed to have other functionality, such as numeric and/or other editing functions that are spreadsheet based.

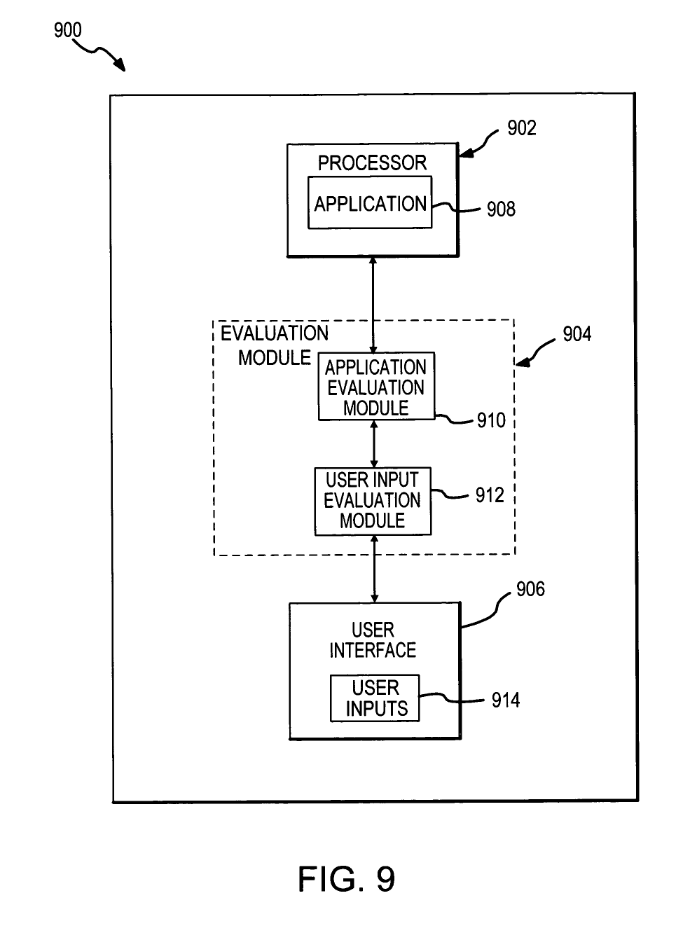

FIG. 9 is a block diagram that shows another exemplary embodiment of a mobile communications system, generally at 900. System 900 may include a processor 902, an evaluation module 904 and a user interface 906, all communicationally coupled as shown. In this embodiment, processor 902 may be configured to execute application 908, and allow application 908 operate within the system 900.

In this embodiment, evaluation module 904 includes an application evaluation module 910 and a user input evaluation module 912. It will be appreciated that the evaluation module 904 may or may not be needed in this embodiment if the application evaluation module 910 and the user input evaluation module 912 provide the functionality needed. It will also be appreciated that the evaluation module 904, application evaluation module 912 and the user input evaluation module 912, may reside in the operating system or in an application module or application program, or other module, either local or remote, as desired. Furthermore, the evaluation module 904 may provide a default programming for user interface 906 and the application 908 program may alter, change and/or otherwise interpret the inputs differently once received, depending on the application program or other considerations.

Similarly, application evaluation module 910 and user input evaluation module 912 may also be located in the operating system or the application program or other location in hardware or software, as desired. In this embodiment, application evaluation module 910 is configured to evaluate the application 908 currently being executed, as well as evaluating what information application 908 may require or may possibly require. Furthermore, application evaluation module 910 may also determine where the focus of the display or document is located.

User input evaluation module 912 may similarly evaluate the type and frequency of inputs among other indicators entering, from user interface 906. The input evaluation module 912 determines the actuation position of the multi-stage actuators such that a determination may be made as to the function to be activated.

The information evaluated from application evaluation module 910 and/or user input evaluation module 912 may then be utilized, among other indicators, to provide a programming of the functions for the user input devices of user interface 906. Therefore, the user inputs may be programmed to provide default and/or typical functionality the user may require or want. Furthermore, as the user inputs from various applications this programming may be changed to personalize the system to most used functions by the particular user.

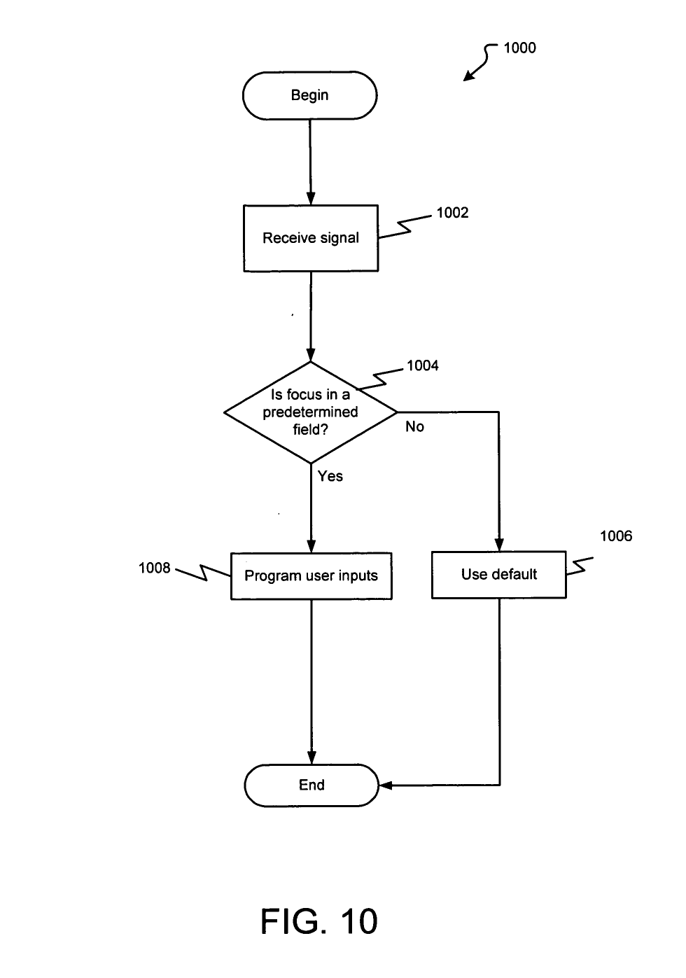

FIG. 10 is a flow diagram of a method 1000 for determining is an actuator is to be programmed, or if the actuator is to have default functionality. Method 1000 begins with receiving a signal from an input device at 1002. The signal may include the particular user input that is being received, or that determination may be made in other ways. Control then passes to the determination function as 1004. Determine function 1004 determined if the focus is in a predetermined field. The predetermined field may be one that would cause the functions associated with the user inputs to be changed from default functionality.

If it is determined that the focus is in a predetermined field, user inputs are programmed 1008 to the functionality that may be related to the field in which the focus is located. It will be appreciated that the functionality associated with the user inputs also may not be related to where the focus is located, as desired. If the focus is not in a predetermined field, the default functions associated with the user inputs will be utilized at 1006.

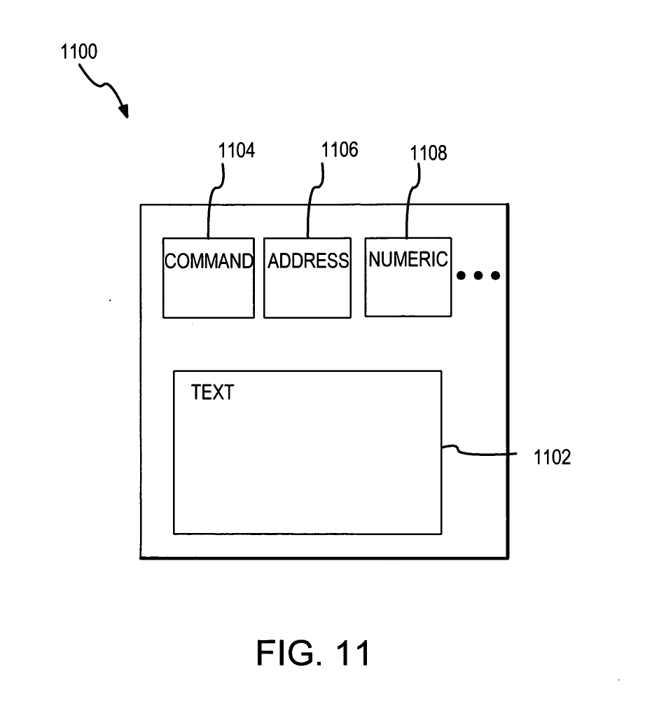

FIG. 11 shows a document and/or display according to an exemplary embodiment, generally at 1100. Document and/or display 1100 in this embodiment includes a command portion 1102, text portion 1104, an address portion 1106 and a numeric portion 1108. As described above, if the focus is in one of these areas, the program functionality for the user inputs may be different based upon this information, as well as other information. It will be appreciated that many more types of predetermined fields may be within a document and/or displayed by the user interface such that different functionality may be programmed to the user inputs accordingly. As described above, there may be a time delay for the first actuation position of the multi-stage actuator such that the user may not inadvertently activate a first function inadvertently while trying to activate a second function associated with the same multi-stage actuator.

The logical operations of the various embodiments of the exemplary embodiments may be implemented (1) as a sequence of computer implemented acts or program modules running on a computing system and/or (2) as interconnected machine logic circuits or circuit modules within the computing system, or combinations thereof. The implementation is a matter of choice dependent on the performance requirements of the computing system implementing the invention. Accordingly, the logical operations making up the embodiments of the exemplary embodiments described herein are referred to variously as operations, structural devices, acts or modules. It will be recognized by one skilled in the art that these operations, structural devices, acts and modules may be implemented in software, in firmware, in special purpose digital logic, and/or any combination thereof without deviating from the spirit and scope of the present disclosure as recited within the claims attached hereto.

Although the exemplary embodiments have been described in language specific to computer structural features, methodological acts and by computer readable media, it is to be understood that the exemplary embodiments defined in the appended claims is not necessarily limited to the specific structures, acts or media described. Therefore, the specific structural features, acts and mediums are disclosed as exemplary embodiments implementing the claimed invention.

The various embodiments described above are provided by way of illustration only and should not be construed to limit this disclosure. Those skilled in the art will readily recognize various modifications and changes that may be made to the present disclosure without following the exemplary embodiments and applications illustrated and described herein, and without departing from the true spirit and scope of the present disclosure, which is set forth in the following claims.

What is claimed is:

1. A mobile communication device, comprising:
an application module executing an application program;
a user interface portion comprising a multi-function actuator comprising different actuation positions;
wherein the application module is configured to program the functionality of the actuation positions of the multi-stage actuator based at lest in part upon a focus.

2. The mobile communication device of claim 1, wherein the multi-function actuator has multiple actuation positions.

3. The mobile communication device of claim 1, wherein the user interface comprises a user input portion.

4. The mobile communication device of claim 3, further comprising an evaluation module configured to control the function associated with the user input portion, based at least in part upon the focus.

5. The mobile communication device of claim 4, wherein the evaluation module further comprises an application evaluation module and a user input evaluation module.

6. The mobile communication device of claim 3, further comprising an evaluation module configured to control the function associated with the user input portion, based at least in part upon inputs received from the user input portion.

7. The mobile communication device of claim 5, wherein the evaluation module further comprises an application evaluation module and a user input evaluation module.

8. The mobile communication device of claim 1, wherein the application program manipulates a document comprising text, and the user input portion is programmed to activate text-editing functions.

9. A mobile communication device, comprising:
a processor executing an application program, the application program configured to display a document to a user, the document comprising a text portion capable of focus on the text portion;
a user interface comprising a programmable, multi-stage actuator, and a display portion configured to display the document;
wherein the multi-stage actuator is configured to execute text-editing functions, upon actuation, when the focus is on the text portion of the document.

10. The mobile communication device of claim 9, further comprising a programmable user input portion, comprising actuators.

11. The mobile communication device of claim 10, further comprising an application evaluation module in communication with the application program, configured to determine the focus, and to associate functionality with the user input portion.

12. The mobile communication device of claim 10, further comprising a user input evaluation module in communication with the user input portion, configured to determine an actuation position of the actuator.

13. The mobile communication device of claim 11, wherein the functionality associated with the user input portion is based at least in part upon the focus.

14. The mobile communication device of claim 9, wherein the multistage actuator is configured to provide a plurality of actuation positions.

15. The mobile communication device of claim 9, wherein the text-editing functions comprise at least one of cut, copy, past, delete, select, format, format painter, undo, redo, repeat, paste special, paste hyperlink, find, replace, insert, spell check, thesaurus, save, print, or email.

16. A mobile communication system, comprising:
an application module executing an application program;
a user interface comprising a multi-stage actuator, configured to provide inputs to the system; and
an evaluation module in communication with the user interface and the application module, configured to program the function of the user interface inputs based at least in part upon the focus.

17. The mobile communication system of claim 16, wherein the evaluation module comprises a user interface evaluation module and an application evaluation module.

18. The mobile communication system of claim 16, wherein the evaluation module programming of the user interface inputs is based at least in part upon the application program.

19. The mobile communication system of claim 16, wherein the evaluation module programming of the user interface inputs is based at least in part upon the user interface inputs.

20. The mobile communication system of claim 16, further comprising a memory and processor, the memory configured to store the application module and the processor configured to allow the application module to execute the application program.
